(19) United States
(12) Patent Application Publication
(10) Pub. No.: US 2026/0155059 A1
(43) Pub. Date: Jun. 4, 2026

(54) ROAD SIMULATION TEST APPARATUS FOR VEHICLE CAB

(71) Applicant: Beijing G&R HR Service Co.,Ltd, Beijing (CN)

(72) Inventor: Yuhai MA, Beijing (CN)

(73) Assignee: Beijing G&R HR Service Co.,Ltd, Beijing (CN)

(21) Appl. No.: 19/248,539

(22) Filed: Jun. 25, 2025

(30) Foreign Application Priority Data
Dec. 4, 2024 (CN) 202411764987.4

(51) Int. Cl. G09B 9/042

(52) U.S. Cl. CPC G09B 9/042

(57) ABSTRACT

A road simulation test apparatus for a vehicle cab includes a main body structure, an external rearview component, a directional structure, and a control box. The main body structure is detachably installed in a cab and connected to the control box. The external rearview component is detachably disposed on external rearview mirrors and connected to the control box, and the directional structure is detachably disposed on a steering wheel and wirelessly connected to the control box. The road simulation test apparatus is powered on by directly connecting the control box to an OBD (On-Board Diagnostics) interface of the cab, front dashboard display screens and an internal rearview screen are used to achieve projection simulation of pictures, and an external rearview component is configured to achieve projection simulation of pictures of external rearview mirrors.

### CROSS-REFERENCE TO THE RELATED APPLICATIONS

This application is based upon and claims priority to Chinese Patent Application No. 202411764987.4, filed on Dec. 4, 2024, the entire contents of which are incorporated herein by reference.

### TECHNICAL FIELD

The present disclosure relates to the technical field of simulated driving device, and in particular to a road simulation test apparatus for a vehicle cab.

### BACKGROUND

Driving simulator is a teaching device for driving training, which can create a virtual driving training environment by using a virtual reality simulation technology, and people can interact with the virtual environment through operating parts of the simulator to carry out driving training in a broad sense.

The existing simulated driving device is fixed in a room, which imitates a real automobile cab structure for the training of students. However, the existing device is quite different from a real vehicle, making both the sense of vision and space different during driving. A practical operation is required to train the road driving skills. Therefore, a road simulation test apparatus for a vehicle cab is designed, which is mounted in a real cab and used to simulate road driving experience with the help of the real vehicle.

### SUMMARY

An objective of the present disclosure is to provide a road simulation test apparatus for a vehicle cab to solve the problems in the background described above.

To solve the problem above, the present disclosure provides the following technical solutions: a road simulation test apparatus for a vehicle cab includes a main body structure, an external rearview component, a directional structure, and a control box. The main body structure is detachably mounted in a cab and connected to the control box, the external rearview component is detachably disposed on external rearview mirrors and connected to the control box, and the directional structure is detachably disposed on a steering wheel and wirelessly connected to the control box. The control box is of a rectangular structure and provided with a display screen and control buttons on an upper wall of the control box. A control mainboard is arranged in the control box, and an on-board diagnostics (OBD) adapter cable is connected to the control box. The control box is further provided with multiple adapter ports and universal serial bus (USB) interfaces connected to the main body structure and the external rearview component.

Preferably, the main body structure includes a pair of front dashboard display screens, a pair of adapter bases, two pairs of adapter arms, a plurality of first bolts, a support base, a swivel base, a first swivel arm, a second swivel arm, an internal rearview screen, and a pair of clamping arms. The pair of front dashboard display screens are detachably aligned and spliced, and the front dashboard display screens are connected in series via a first wire. The pair of adapter bases are both inverted-H shaped, and symmetrically arranged between and located at a rear side of the pair of front dashboard display screens. Ends of the two pairs of adapter arms are movably embedded into two ends of the adapter bases by the plurality of bolts, and the other ends of the adapter arms are connected to upper and lower sidewalls of opposite ends of the front dashboard display screens by the plurality of first bolts. The support base is of a rectangular structure and provided with a threaded stud in a middle portion of an upper wall of the support base, and the support base is detachably and threadedly connected to a middle portion of a lower wall of one of the adapter bases by the threaded stud and located below the front dashboard display screens. One end of the swivel base is detachably and threadedly connected to a middle portion of an upper wall of other one of the adapter bases and located above the front dashboard display screen. The first swivel arm is of a rectangular frame structure, one end of the first swivel arm is movably embedded into the other end of the swivel base, and the first swivel arm can perform swivel motion in the swivel base to adjust an angle. One end of the second swivel arm is detachably clamped into the other end of the first swivel arm, and the second swivel arm can slide and perform swivel motion on the first swivel arm. The second swivel arm is of a T-shaped structure and provided with arc-shaped hanging arms on front sidewalls of two ends of the second swivel arm. T-shaped through slots are formed in middle portions of ends of the hanging arms, the internal rearview screen is detachably disposed on the hanging arms. The pair of clamping arms are both T-shaped, ends of the pair of clamping arms are symmetrically and movably connected to a rear sidewall of the internal rearview screen, and the other ends of the clamping arms run through the slots, respectively.

In some embodiments, the external rearview component includes a pair of external rearview screens and a pair of claws. The pair of external rearview screens are provided with second wires respectively, and the external rearview screens are connected to the control box. The pair of claws are detachably disposed on upper walls of the external rearview screens, respectively. The claws are of U-shaped structures, and are able to be clamped onto the external rearview mirrors, respectively.

In some embodiments, the directional structure includes a housing, a housing cover, an on/off button, a rotation sensor, a pair of batteries, a wireless control module, a flywheel, a pair of clamping plates, and mounting bolts. The housing is of a circular structure and provided with a charging port on a front sidewall of the housing; the housing cover is detachably buckled into the housing, the on/off button is fixedly arranged on a sidewall of the housing and adjacent to the charging port, and the rotation sensor is fixedly arranged at a middle portion of an inner lower wall of the housing, and a rotating shaft of the rotation sensor is concentric with the housing. The pair of batteries are fixedly arranged on the inner lower wall of the housing and respectively located on front and rear sides of the rotation sensor. The wireless control module is fixedly arranged on a left side of the rotation sensor, the flywheel fixedly sleeves the rotation sensor, and can rotate through the rotation sensor. The pair of clamping plates are both an arched structure with a same diameter; two ends of the pair of clamping plates are in butt joint by the mounting bolts, and one end of one clamping plate is fixedly arranged on the housing.

In some embodiments, the directional structure is mounted on the steering wheel by the clamping plates.

In some embodiments, a tilt angle of the internal rearview screen can be adjusted by the clamping arm.

In some embodiments, the hanging arms are movably clamped onto the internal rearview mirror.

In some embodiments, the control box is provided with a training module, and connected to a vehicle's system by the OBD adapter cable to be powered.

A road simulation test apparatus for a vehicle cab provided by the present disclosure has the beneficial effects of:
First. High integration and convenient connection: the control box is directly connected to an OBD interface of the cab to be powered, which simplifies a mounting process of the apparatus, enables the apparatus to be quickly integrated into an existing cab, and reduces the complexity and time of mounting.
Second. Real visual experience: the front dashboard display screens and the internal rearview screen are used to achieve projection simulation of pictures, and the external rearview component is configured to achieve projection simulation of pictures from an external rearview mirror. These functions can provide more realistic visual experience and make the driver feel a visual experience close to real driving in a simulated environment.
Third. Real driving feeling: by mounting the directional structure in the middle portion of a bottom end of the steering wheel and rotating the steering wheel at a corresponding angle under the gravity of the flywheel, actual rotating feeling of the steering wheel can be simulated, thereby providing a more realistic driving experience and a high degree of simulation.
Fourth. Flexibility and expandability: since the apparatus is connected and controlled by the control box, this design may allow the apparatus to be upgraded or expanded in the future to meet novel technical and functional requirements.
Fifth. Security: driving simulation indoors can reduce a risk of actual road driving and provide a safe learning and practice environment for the driver.
Sixth. Cost efficiency: by simulating the driving, the use and wear of an actual vehicle can be reduced, thereby reducing the training cost.

### BRIEF DESCRIPTION OF THE DRAWINGS

FIG. 1 is a structural schematic diagram of an assembled display according to the present disclosure;

FIG. 2 is a structural schematic diagram of a unassembled main body structure according to the present disclosure;

FIG. 3 is a structural schematic diagram of an external rearview component according to the present disclosure;

FIG. 4 is a structural schematic diagram of a unassembled directional structure according to the present disclosure;

FIG. 5 is a partially enlarged structural schematic diagram of area A according to the present disclosure;

FIG. 6 is a partially enlarged structural schematic diagram of area B according to the present disclosure;

FIG. 7 is a partially enlarged structural schematic diagram of area C according to the present disclosure;

FIG. 8 is a partially enlarged structural schematic diagram of area D according to the present disclosure.

In the drawings: 1—main body structure; 11—front dashboard display screen; 12—adapter base; 13—adapter arm; 14—first bolt; 15—support base; 16—swivel base; 17—first swivel arm; 18—second swivel arm; 19—internal rearview screen; 20—clamping arm; 2—external rearview component; 21—external rearview screen; 22—claw; 3-directional structure; 31—housing; 32—housing cover; 33—on/off button; 34—rotation sensor; 35—battery; 36—wireless control module; 37—flywheel; 38—clamping plate; 39—mounting bolt; 4—control box; 41—adapter port; 42—OBD adapter cable; 5—hanging arm.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by those of ordinary skill in the art based on the embodiments of the present disclosure without creative efforts shall fall within the scope of protection of the present disclosure.

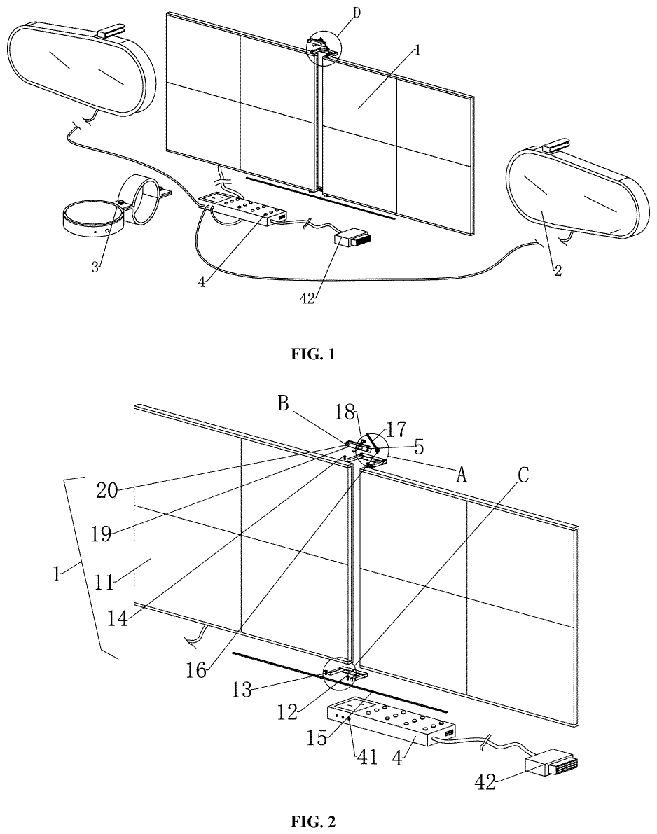

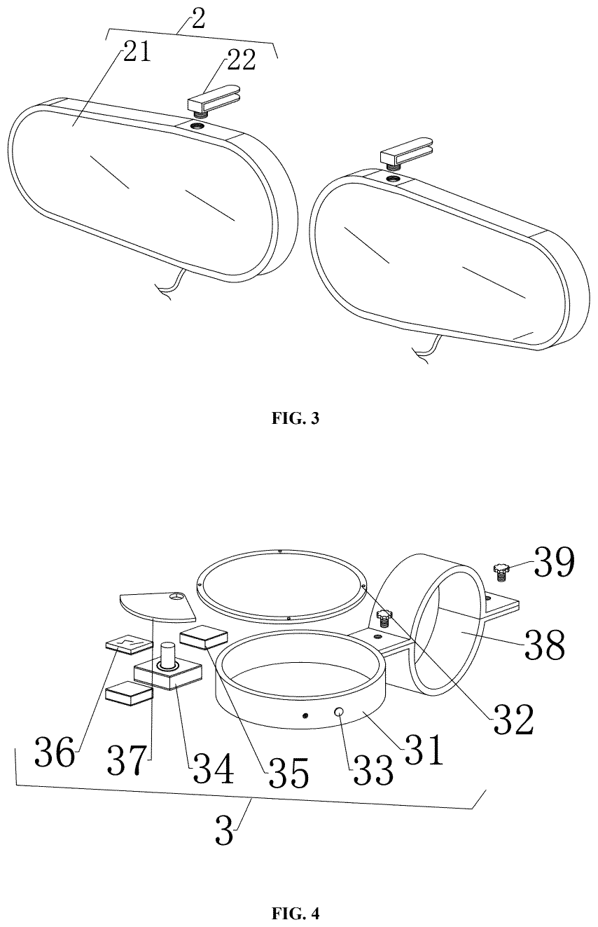

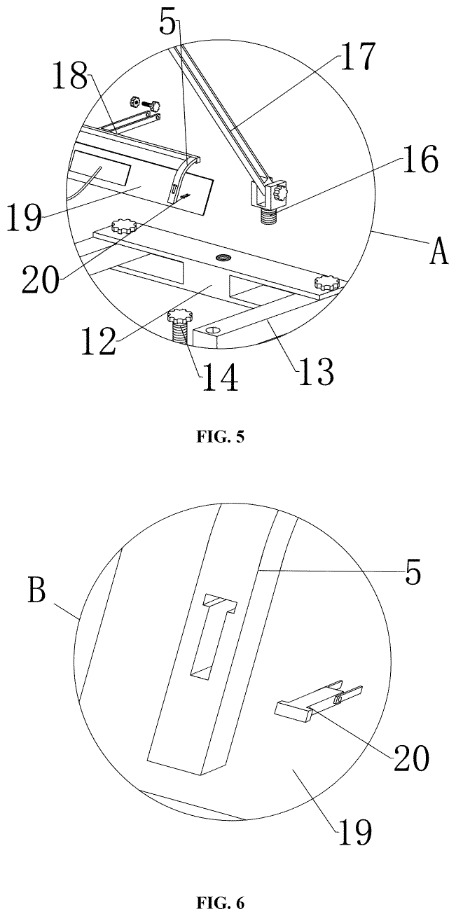

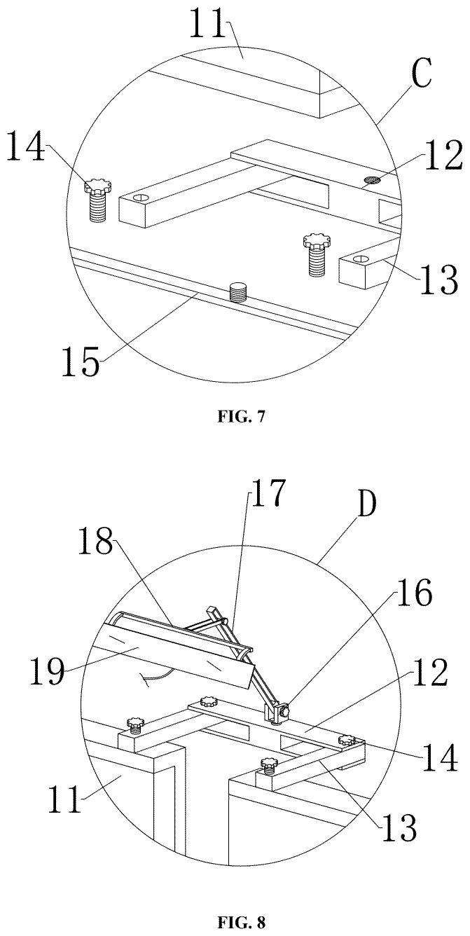

Please refer to FIGS. 1 to 8, the present disclosure provides a technical solution: a road simulation test apparatus for a vehicle cab includes a main body structure 1, an external rearview component 2, a directional structure 3, and a control box 4. The main body structure 1 is detachably mounted in a cab and connected to the control box 4, the external rearview component 2 is detachably disposed on external rearview mirrors and connected to the control box 4, and the directional structure 3 is detachably disposed on a steering wheel and wirelessly connected to the control box 4. The control box 4 is of a rectangular structure, and is provided with a display screen and control buttons on an upper wall of the control box. A control mainboard is arranged in the control box 4, and an OBD (On-Board Diagnostics) adapter cable 42 is connected to the control box 4. The control box 4 is further provided with a plurality of adapter ports 41 and USB interfaces connected to the main body structure 1 and the external rearview component 2. By connecting the control box 4 to the onboard OBD interface for power supply, simulated pictures of a driving system can be projected to a front dashboard, an internal rearview mirror and external rearview mirrors to achieve the observation of simulating an actual width of a vehicle body. By mounting the directional structure 3 on the steering wheel, a simulation operation can be implemented by transmitting a rotation signal of the steering wheel to change projected pictures, thereby achieving high simulation effect.

The following is the model and function of each electrical device in this case.

Rotation sensor: the rotation sensor may be the prior art, and is configured to detect a rotation angle, thereby providing the rotation angle of the steering wheel.

Control box: the control box employs a simulator module in the prior art, and is internally provided with a corresponding training scene module, control module and wireless module.

As a further solution of the present disclosure, the main body structure 1 includes a pair of front dashboard display screens 11, a pair of adapter bases 12, two pairs of adapter arms 13, a plurality of first bolts 14, a support base 15, a swivel base 16, a first swivel arm 17, a second swivel arm 18, an internal rearview screen 19, and a pair of clamping arms 20. The pair of front dashboard display screens 11 are detachably aligned and spliced, and the front dashboard display screens 11 are connected in series via a first wire. The pair of adapter bases 12 are both inverted-H shaped, and symmetrically arranged between and located at a rear side of the pair of front dashboard display screens. Ends of the two pairs of adapter arms 13 are movably embedded into two ends of the adapter bases 12 by the plurality of bolts 14, and the other ends of the adapter arms 13 are connected to upper and lower sidewalls of opposite ends of the front dashboard display screens 11 by the plurality of first bolts 14. The support base 15 is of a rectangular structure and provided with a threaded stud on a middle portion of an upper wall of the support base, and the support base 15 is detachably and threadedly connected to a middle portion of a lower wall of one of the adapter bases 12 by the threaded stud and located below the front dashboard display screens 11. One end of the swivel base 16 is detachably and threadedly connected to a middle portion of an upper wall of the other one of the adapter bases 12 and located above the front dashboard display screens 11. The first swivel arm 17 is of a rectangular frame structure, one end of the first swivel arm 17 is movably embedded into the other end of the swivel base 16, and the first swivel arm 17 can perform swivel motion in the swivel base 16 to adjust an angle. One end of the second swivel arm 18 is detachably clamped into the other end of the first swivel arm 17, and the second swivel arm 18 can slide and perform swivel motion on the first swivel arm 17. The second swivel arm 18 is of a T-shaped structure and provided with arc-shaped hanging arms 5 on front sidewalls of two ends of the second swivel arm. T-shaped through slots are formed in middle portions of ends of the hanging arms 5, the internal rearview screen 19 is detachably disposed on the hanging arms 5. The pair of clamping arms 20 are both T-shaped, ends of the pair of clamping arms 20 are symmetrically and movably connected to a rear sidewall of the internal rearview screen 19, and the other ends of the clamping arms 20 run through the slots, respectively. The hanging arms 5 are hung and fixed to the onboard internal rearview mirror, the front dashboard display screens 11 are butted by the adapter bases 12 and the adapter arms 13, and then mounted at a front dashboard of a center console in the vehicle, and then supported at the bottom by the support base 15. The butted front dashboard display screens 11 can move and rotate for adjustment on the first swivel arm 17 by the second swivel arm 18; and the first swivel arm 17 can perform swivel motion for adjustment on the swivel base 16, thereby enabling the hanging arms 5 to be effectively hung on the interior rearview mirror for mounting and use.

As a further solution of the present disclosure, the external rearview component 2 includes a pair of external rearview screens 21 and a pair of claws 22. The pair of external rearview screens 21 are provided with a second wire respectively, and the external rearview screens 21 are connected to the control box 4. The pair of claws 22 are detachably disposed on upper walls of the external rearview screens 21, respectively. The claws 22 are of U-shaped structures, and can be clamped onto the external rearview mirrors, respectively. Through the claws 21, the external rearview screens 21 can be clamped to shells of onboard external rearview mirrors for mounting.

As a further solution of the present disclosure, the directional structure 3 includes a housing 31, a housing cover 32, an on/off button 33, a rotation sensor 34, a pair of batteries 35, a wireless control module 36, a flywheel 37, a pair of clamping plates 38, and mounting bolts 39. The housing 31 is of a circular structure and provided with a charging port on a front sidewall of the housing; the housing cover 32 is detachably buckled into the housing 31, the on/off button 33 is fixedly arranged on a sidewall of the housing 31 and adjacent to the charging port, and the rotation sensor 34 is fixedly arranged at a middle portion of an inner lower wall of the housing 31, and a rotating shaft of the rotation sensor 34 is concentric with the housing 31. The pair of batteries 35 are fixedly arranged on the inner lower wall of the housing 31 and respectively located on front and rear sides of the rotation sensor 34. The wireless control module 36 is fixedly arranged on a left side of the rotation sensor 34, the flywheel 37 fixedly sleeves the rotation sensor 34, and can rotate through the rotation sensor 34; the pair of clamping plates 38 are both an arched structure with a same diameter. Two ends of the pair of clamping plates 38 are in butt joint by the mounting bolts 39, and one end of one clamping plate 38 is fixedly arranged on the housing 31. The housing 31 is mounted on the steering wheel through the mating of the clamping plates 38 and the mounting bolts 39. Because the steering wheel is inclined, the housing is mounted in the middle portion of a bottom end of the steering wheel, which can facilitate the flywheel 37 to be downward by gravity. When the steering wheel rotates, as the flywheel 37 tilts along with the steering wheel, the flywheel 37 keeps downward by its own gravity when the steering wheel rotates, and then the rotation of the steering wheel can drive the rotation sensor 34 to rotate by a corresponding angle by means of the flywheel 37, and the rotation angle of the rotation sensor 34 is transmitted to the control box 4 to simulate a rotation angle of the steering wheel in the simulated driving pictures.

As a further solution of the present disclosure, the directional structure 3 is mounted on the steering wheel by the clamping plates 38 for design, mounting and use demands.

As a further solution of the present disclosure, a tilt angle of the inner rearview screen 19 can be adjusted through the clamping arms 20 for design demands and achieving observation and use of students with different heights.

As a further solution of the present disclosure, the hanging arms 5 are movably clamped on the inner rearview mirror for design and mounting demands in the actual cab.

As a further solution of the present disclosure, the control box 4 is provided with a training module, and connected to a vehicle's system through an OBD adapter cable 42 to be powered, which is mounted in the vehicle and powered to achieve high simulation.

Detailed connection means are well known in the art, and the following mainly introduces the working principle and process, and the specific work is as follows.

Working principle:
First, the front dashboard display screens 11 in the main body structure 1 are flip, and then are butted, fitted and fixed by the first bolts 14 through the swivel of the adapter arms 13 in the adapter bases 12, then the adapter base 12 at the bottom of the front dashboard display screens 11 is mounted on the support base 15, That is, the front dashboard display screens 11 can be placed at a front dashboard of the center console, the bottoms of the front dashboard display screens are supported by the support base 15 to swing. The tops of the front dashboard display screens 11 are hung and fixed to the internal rearview mirror by the hanging arms 5. According to different vehicle bodies, the first swivel arm 17 is adjusted to swivel on the swivel base 16 to adjust the height and the front-to-rear distance of the hanging arms 5, the second swivel arm 18 moves on the first swivel arm 17 to further adjust the height and rotates to adjust the position for fitting.

After the front dashboard display screens 1 are fixed, the hanging arms 5 are located at a front side of the internal rearview mirror, and then internal rearview screen 19 can be mounted by inserting the clamping arms 20 into the hanging arms 5, and the internal rearview screen 19 can be swiveled at a certain angle for adjustment.

Secondly, after mounting the claws 22 in the external rearview component 2 on the external rearview screens 21, the external rearview component 2 is clamped on the upper shells of the external rearview mirror by the claws 22, and the external rearview screens 21 shield the external rearview mirrors. Then, the control box 4 is placed on the center console and are connected to the front dashboard display screens 11, the internal rearview screen 19 and the external rearview screens 21 by means of the adapter ports 41, an OBD adapter cable is connected to the onboard OBD interface for power supply.

Finally, the housing in the directional structure 3 is clamped to the middle portion of the bottom end of the inclined steering wheel by two opposite clamping plates 38, and the clamping plates 38 are relatively clamped and fixed by the mounting bolts 39 to complete the mounting.

During use, by pressing the on/off button 33, a wireless control module 36 and the rotation sensor 34 sealed by the housing cover 32 are powered by the batteries 35. The wireless control module 36 is wirelessly connected to the control box 4, and then pictures can be projected to the front dashboard display screens 11, the intern rearview screen 19 and the external rearview screens 21 by a simulation training system in the control box 4 for replacement to achieve the simulation of a front-facing road condition, a scene of the internal rearview and scenes of the external rearview mirrors. In addition, it enables real perception of in-vehicle visual perspective, haptic feedback, and physical vehicle width through the real body. Rotation can be carried out through a real onboard steering wheel, by means of a design that the flywheel 27 is inclined along with the mounting of the steering wheel, a vertical middle portion of the flywheel 27 is always kept at a downward state (for example, when the flywheel in a mechanical watch, the watch body rotates, but the flywheel 37 remains unchanged). That is, the flywheel can rotate leftward or rightward along with the steering wheel to drive a shaft of the rotation sensor 34 to rotate, thereby controlling the direction in the pictures of the simulation training. That is, the real feeling and training use of the vehicle's body are achieved as a whole.

A rotation angle of the steering wheel may change the height and position of the housing 31, that is, the height and position are different. When the flywheel 37 changes along with the housing 31, the shaft of the rotation sensor is driven to rotate for simple motion transmission control adjustment.

Although the embodiments of the present disclosure have been shown and described, those skilled in the art can understand that many changes, modifications, substitutions and variations can be made to these embodiments without departing from the principles and purposes of the present disclosure, and the scope of the present disclosure is defined by the claims and their equivalents.

What is claimed is:

1. A road simulation test apparatus for a vehicle cab, comprising: a main body structure, an external rearview component, a directional structure, and a control box, wherein
the main body structure is detachably mounted in a cab and connected to the control box, the external rearview component is detachably disposed on external rearview mirrors and connected to the control box, and the directional structure is detachably disposed on a steering wheel and wirelessly connected to the control box; the control box is of a rectangular structure, and is provided with a display screen and control buttons on an upper wall of the control box; a control mainboard is arranged in the control box, and an on-board diagnostics (OBD) adapter cable is connected to the control box; the control box is further provided with a plurality of adapter ports and universal serial bus (USB) interfaces connected to the main body structure and the external rearview component;
the main body structure comprises a pair of front dashboard display screens, a pair of adapter bases, two pairs of adapter arms, a plurality of first bolts, a support base, a swivel base, a first swivel arm, a second swivel arm, an internal rearview screen, and a pair of clamping arms;
the pair of front dashboard display screens are detachably aligned and spliced, and are connected in series via a first wire; the pair of adapter bases are both inverted-H shaped, and symmetrically arranged between and located at a rear side of the pair of front dashboard display screens; first ends of the two pairs of adapter arms are movably embedded into two ends of the pair of adapter bases by the plurality of bolts, and second ends of the two pairs of adapter arms are connected to upper and lower sidewalls of opposite ends of the pair of front dashboard display screens by the plurality of first bolts; the support base is of a rectangular structure and provided with a threaded stud on a middle portion of an upper wall of the support base, is detachably and threadedly connected to a middle portion of a lower wall of a first adapter base of the pair of adapter bases by the threaded stud, and is located below the pair of front dashboard display screens; a first end of the swivel base is detachably and threadedly connected to a middle portion of an upper wall of a second adapter base of the pair of adapter bases and located above the pair of front dashboard display screens; the first swivel arm is of a rectangular frame structure, a first end of the first swivel arm is movably embedded into a second end of the swivel base, and the first swivel arm is configured to swivel in the swivel base to adjust an angle; an end of the second swivel arm is detachably clamped into a second end of the first swivel arm, and the second swivel arm is configured to slide and swivel on the first swivel arm; the second swivel arm is of a T-shaped structure and provided with arc-shaped hanging arms on front sidewalls of two ends of the second swivel arm; T-shaped through slots are formed in middle portions of ends of the arc-shaped hanging arms; the internal rearview screen is detachably disposed on the arc-shaped hanging arms; the pair of clamping arms are both T-shaped, first ends of the pair of clamping arms are symmetrically and movably connected to a rear sidewall of the internal rearview screen, and second ends of the pair of clamping arms run through the T-shaped through slots, respectively;
the external rearview component comprises a pair of external rearview screens and a pair of claws; the pair of external rearview screens are provided with second wires respectively, and the pair of external rearview screens are connected to the control box; the pair of claws are detachably disposed on upper walls of the pair of external rearview screens, respectively; and the pair of claws are of U-shaped structures, and are configured to be clamped onto the external rearview mirrors, respectively;
the directional structure comprises a housing, a housing cover, an on/off button, a rotation sensor, a pair of batteries, a wireless control module, a flywheel, a pair of clamping plates, and mounting bolts; and
the housing is of a circular structure and provided with a charging port on a front sidewall of the housing; the housing cover is detachably buckled into the housing, the on/off button is fixedly arranged on a sidewall of the housing and adjacent to the charging port, and the rotation sensor is fixedly arranged at a middle portion of an inner lower wall of the housing, and a rotating shaft of the rotation sensor is concentric with the housing; the pair of batteries are fixedly arranged on the inner lower wall of the housing and respectively located on front and rear sides of the rotation sensor; the wireless control module is fixedly arranged on a left side of the rotation sensor; the flywheel fixedly sleeves the rotation sensor, and is configured to rotate through the rotation sensor; the pair of clamping plates are both an arched structure with a same diameter; two ends of the pair of clamping plates are in butt joint by the mounting bolts, and an end of a clamping plate of the pair of clamping plates is fixedly arranged on the housing.

2. The road simulation test apparatus for the vehicle cab according to claim 1, wherein the directional structure is mounted on the steering wheel by the pair of clamping plates.

3. The road simulation test apparatus for the vehicle cab according to claim 2, wherein
a tilt angle of the internal rearview screen is configured to be adjusted by the pair of clamping arms.

4. The road simulation test apparatus for the vehicle cab according to claim 3, wherein the arc-shaped hanging arms are movably clamped onto an internal rearview mirror.

5. The road simulation test apparatus for the vehicle cab according to claim 4, wherein
the control box is provided with a training module, and connected to a vehicle's system through the OBD adapter cable to be powered.
